(19) United States
(12) Patent Application Publication
(10) Pub. No.: US 2026/0080288 A1
(43) Pub. Date: Mar. 19, 2026

(54) Newton-Type Method for Phase Factor Determination in Quantum Signal Processing

(71) Applicant: International Business Machines Corporation, Armonk, NY (US)

(72) Inventors: Mitsuharu TAKEORI, Kashiwa-city (JP); Takahiro YAMAMOTO, Bunkyo-ku (JP); Patrick Julian Tassilo RALL, Boston, MA (US)

(21) Appl. No.: 18/888,622

(22) Filed: Sep. 18, 2024

(51) Int. Cl. G06N 10/40

(52) U.S. Cl. CPC G06N 10/40

(57) ABSTRACT

Systems and techniques that facilitate phase factor determination in quantum signal processing are provided. Various embodiments described herein comprise a system, which can comprise: a memory that can store computer executable components; and a processor, operably coupled to the memory, that can execute at least one of the computer executable components that can receive a first target real-valued function and a second target real-valued function that represent a target transformation on a quantum state; determine a system of non-linear equations based on the first target real-valued function and the second target real-valued function, the system of non-linear equations comprising a number of phase factors that define parameters of quantum operations; determine the phase factors using a modified Newton method to iteratively solve the system of non-linear equations; and configure the quantum processor to apply the phase factors to a quantum circuit to implement the target transformation on the quantum state.

### BACKGROUND

The subject disclosure relates to quantum signal processing, and more specifically, to a Newton-type method for phase factor determination in quantum signal processing.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate a Newton-type method for phase factor determination in quantum signal processing are provided.

According to an embodiment, a system can comprise a memory that stores computer executable components. The system can further comprise a processor, operably coupled to the memory, that can execute at least one of the computer executable components that can receive a first target real-valued function and a second target real-valued function that represent a target transformation on a quantum state within a quantum processor. In one or more embodiments, the at least one of the computer executable components can further determine a system of non-linear equations based on the first target real-valued function and the second target real-valued function, the system of non-linear equations comprising a number of phase factors that define parameters of quantum operations. In one or more embodiments, the at least one of the computer executable components can further determine the phase factors to implement the target transformation by using a modified newton method to iteratively solve the system of non-linear equations. In one or more embodiments, the at least one of the computer executable components can further configure the quantum processor to apply the phase factors to a quantum circuit to implement the target transformation on the quantum state.

According to another embodiment, a computer-implemented method can comprise receiving, by a system operatively coupled to a processor, a first target real-valued function and a second target real-valued function that represent a target transformation on a quantum state within a quantum processor. In one or more embodiments, the computer-implemented method can further comprise determining, by the system, a system of non-linear equations based on the first target real-valued function and the second target real-valued function, the system of non-linear equations comprising a number of phase factors that define parameters of quantum operations. In one or more embodiments, the computer-implemented method can further comprise determining, by the system, the phase factors to implement the target transformation by using a modified newton method to iteratively solve the system of non-linear equations. In one or more embodiments, the computer-implemented method can further comprise configuring, by the system, the quantum processor to apply the phase factors to a quantum circuit to implement the target transformation on the quantum state.

According to another embodiment, a computer program product for phase factor determination in quantum signal processing comprising a computer readable storage medium having program instructions embodied therewith, the program instructions executable by a processor to cause the processor to receive a first target real-valued function and a second target real-valued function that represent a target transformation on a quantum state within a quantum processor. In one or more embodiments, the program instructions can be further executable by the processor to cause the processor to determine a system of non-linear equations based on the first target real-valued function and the second target real-valued function, the system of non-linear equations comprising a number of phase factors that define parameters of quantum operations. In one or more embodiments, the program instructions can be further executable by the processor to cause the processor to determine the phase factors to implement the target transformation by using a modified newton method to iteratively solve the system of non-linear equations. In one or more embodiments, the program instructions can be further executable by the processor to cause the processor to configure the quantum processor to apply the phase factors to a quantum circuit to implement the target transformation on the quantum state.

### DESCRIPTION OF THE DRAWINGS

FIG. 1 illustrates a block diagram of example, non-limiting system that can facilitate a Newton-type method for phase factor determination in quantum signal processing in accordance with one or more embodiments described herein.

FIG. 2 illustrates a block diagram of example, non-limiting system including an approximation component that can facilitate a Newton-type method for phase factor determination in quantum signal processing in accordance with one or more embodiments described herein.

FIG. 3 illustrates an example, non-limiting block diagram of determining a system of non-linear equations based on a first target real-valued function and a second target real-valued function in accordance with one or more embodiments described herein.

FIG. 4 illustrates an example, non-limiting block diagram of modes for approximating target real-valued functions in accordance with one or more embodiments described herein.

FIG. 5 illustrates an example, non-limiting block diagram of determining phase factors based on an accuracy level and mode in accordance with one or more embodiments described herein.

FIG. 6 illustrates an example, non-limiting diagram of performance results of a Newton-type method for phase factor determination in accordance with one or more embodiments described herein.

FIG. 7 illustrates an example, non-limiting diagram of performance results of a Newton-type method for phase factor determination in accordance with one or more embodiments described herein.

FIG. 8 illustrates an example, non-limiting diagram of performance results of a Newton-type method for phase factor determination in accordance with one or more embodiments described herein.

FIG. 9 illustrates a flow diagram of an example, non-limiting method that can facilitate a Newton-type method for phase factor determination in quantum signal processing in accordance with one or more embodiments described herein.

FIG. 10 illustrates a flow diagram of an example, non-limiting method that can facilitate a Newton-type method for phase factor determination in quantum signal processing in accordance with one or more embodiments described herein.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

According to an embodiment, a system can comprise a memory that stores computer executable components. The system can further comprise a processor, operably coupled to the memory, that can execute at least one of the computer executable components that can receive a first target real-valued function and a second target real-valued function that represent a target transformation on a quantum state within a quantum processor. In one or more embodiments, the at least one of the computer executable components can further determine a system of non-linear equations based on the first target real-valued function and the second target real-valued function, the system of non-linear equations comprising a number of phase factors that define parameters of quantum operations. In one or more embodiments, the at least one of the computer executable components can further determine the phase factors to implement the target transformation by using a modified newton method to iteratively solve the system of non-linear equations. In one or more embodiments, the at least one of the computer executable components can further configure the quantum processor to apply the phase factors to a quantum circuit to implement the target transformation on the quantum state. Such embodiments of the system can provide a number of advantages, including improving processing efficiency of phase factor determination, improving robustness of phase factor determination, and improving convergence performance.

In one or more embodiments of the aforementioned system, the at least one of the computer executable components can further: approximate, based on a mode, the first target real-valued function in a real or imaginary part of a first complex polynomial function, wherein the first complex polynomial function is of a first degree; approximate, based on the mode, the second target real-valued function in a real or imaginary part of a second complex polynomial function, wherein the second complex polynomial function is of a second degree; and configure the quantum processor to apply the phase factors based on the mode used for approximating the first target real-valued function and the second target real-valued function. Such embodiments of the system can provide a number of advantages, including improving processing efficiency of phase factor determination and improving robustness of phase factor determination.

In one or more embodiments of the aforementioned system, the first target real-valued function or the second target real-valued function can correspond to polynomial interpolations at Chebyshev points. Such embodiments of the system can provide a number of advantages, including improving processing efficiency of phase factor determination.

In one or more embodiments of the aforementioned system, the phase factors can represent the first target real-valued function and the second target real-valued function as the first complex polynomial function and the second complex polynomial function respectively if the first target function and the second target function are polynomial functions. Such embodiments of the system can provide a number of advantages, including improving processing efficiency of phase factor determination.

In one or more embodiments of the aforementioned system, the at least one of the computer executable components can further set a level of accuracy of the phase factors for solving the system of non-linear equations to implement the target transformation on the quantum state at the level of accuracy. Such embodiments of the system can provide a number of advantages, including improving accuracy of phase factor determination and improving convergence performance.

In one or more embodiments of the aforementioned system, the number of phase factors can correspond to a maximum degree between the first degree and the second degree. Such embodiments of the system can provide a number of advantages, including improving processing efficiency of phase factor determination.

In one or more embodiments of the aforementioned system, iteratively solving the system of non-linear equations to determine the phase factors to implement the target transformation on the quantum state can comprise using a quasi-Newton method. Such embodiments of the system can provide a number of advantages, including increasing processing efficiency of phase factor determination and improving convergence performance.

In one or more embodiments of the aforementioned system, iteratively solving the system of non-linear equations to determine the phase factors to implement the target transformation on the quantum state can comprise using Newton's method. Such embodiments of the system can provide a number of advantages, including increasing processing efficiency of phase factor determination.

In one or more embodiments of the aforementioned system, the modified Newton method can comprise selecting an initial value of the phase factors, wherein a Jacobian matrix of the system of non-linear equations is orthogonal at the initial value. Such embodiments of the system can provide a number of advantages, including increasing processing efficiency of phase factor determination.

In one or more embodiments of the aforementioned system, the at least one of the computer executable components can further accelerate convergence using Aitken's acceleration technique, wherein Aitken's acceleration technique comprises: modifying a learning rate of iteratively solving the system of non-linear equations based on satisfaction of a criterion; and examining the criterion based on the level of accuracy. Such embodiments of the system can provide a number of advantages, including improving convergence performance and increasing processing efficiency.

According to various embodiments, the above-described system can be implemented as a computer-implemented method or as a computer program product.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Quantum Signal Processing (QSP) is a technique used in quantum computing for applying polynomial transformations to quantum states, allowing approximation of a target function with a complex polynomial. QSP has diverse applications in quantum computing such as fault tolerant quantum algorithms, quantum simulation, quantum machine learning, and solving differential equations. QSP enables the efficient implementation of a desired transformation or function on quantum data by decomposing the operation into a sequence of simpler quantum gates. In particular, QSP represents the complex polynomials of a degree d by employing a product of 2×2 unitary matrices that are characterized by a set of (d+1) real numbers called phase factors. Phase factors, denoted by cD, are critical parameters that define specific operations performed by the quantum gates and are used to construct the unitary matrices that collectively implement the desired polynomial transformation on a quantum state.

However, despite a mathematical guarantee of the existence of the phase factors (D, efficiently and accurately determining the phase factors becomes increasingly difficult as the degree d of the complex polynomial increases, complicating implementation of QSP in practical applications. That is, as the degree d of the complex polynomial increases, the complexity of determining the phase factors grows exponentially, making the problem computationally intensive. The inherent nonlinearity and requirement for high precision further exacerbates the difficulty of determining the phase factors, often leading to unstable or inaccurate results with existing methods. Existing techniques and algorithms exhibit susceptibility to numerical instability, high computational costs, and poor scalability for high-degree polynomials. These limitations can hinder practical implementations of QSP in quantum computing applications. Consequently, a more robust, efficient, and accurate method for phase factor determination can be desirable.

Furthermore, existing methods for phase factor determination in QSP, such as using recursive matrix diagonalization algorithms, leverage linear algebra techniques. Although such existing methods offer a direct mathematical approach for phase factor determination, they can be highly numerically unstable, particularly for large polynomials or systems sensitive to small perturbations (e.g., amplified numerical errors due to a recursive nature of the algorithm, leading to significant inaccuracies in the phase factors). Other existing methods, such as gradient descent methods, that address issues of numerical instability are very limited in the context of phase factor determination in QSP due to the nature of optimization landscapes. More specifically, gradient descent methods are limited in phase factor determination due to the highly non-convex optimization landscape, which contains many local minima, saddle points, and flat regions that can trap the algorithm in suboptimal solutions. Moreover, such methods are sensitive to choices of hyperparameters, such as a learning rate, and can suffer from slow convergence or oscillation. Such limitations make gradient descent methods less reliable for determining phase factors in complex or high-degree polynomial cases where the optimization landscape is more challenging. Therefore, a numerically stable, robust, and accurate method for phase factor determination can be desirable.

In view of the problems discussed above, in relation to phase factor determination in QSP, the present disclosure can be implemented to produce a solution to one or more of these problems by determining the phase factors using a modified Newton method. Newton's method is an iterative numerical technique used to find successively better approximations of roots (or zeros) of a real-valued function by using the real-valued function's derivative. The modified Newton method is a variant of Newton's method that relies solely on a Jacobian matrix evaluated at an initial value for iteratively performing updates. By using the modified Newton method, the number of evaluations of the Jacobian matrix can be reduced to one evaluation at the initial value, thereby improving processing efficiency for determining the phase factors. Therefore, determining the phase factors using a modified Newton method can improve the efficiency, robustness, and accuracy of determining the phase factors in QSP.

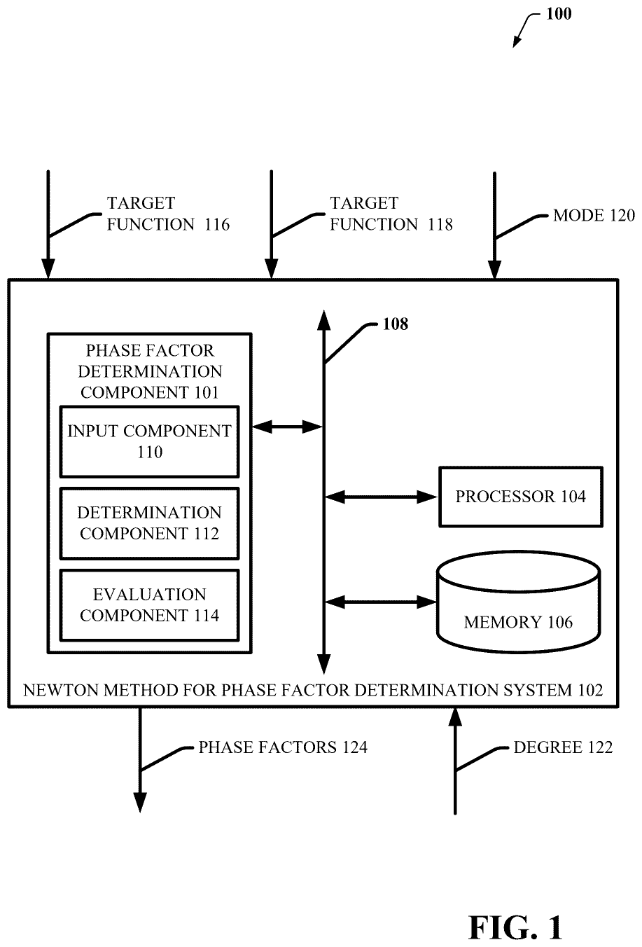

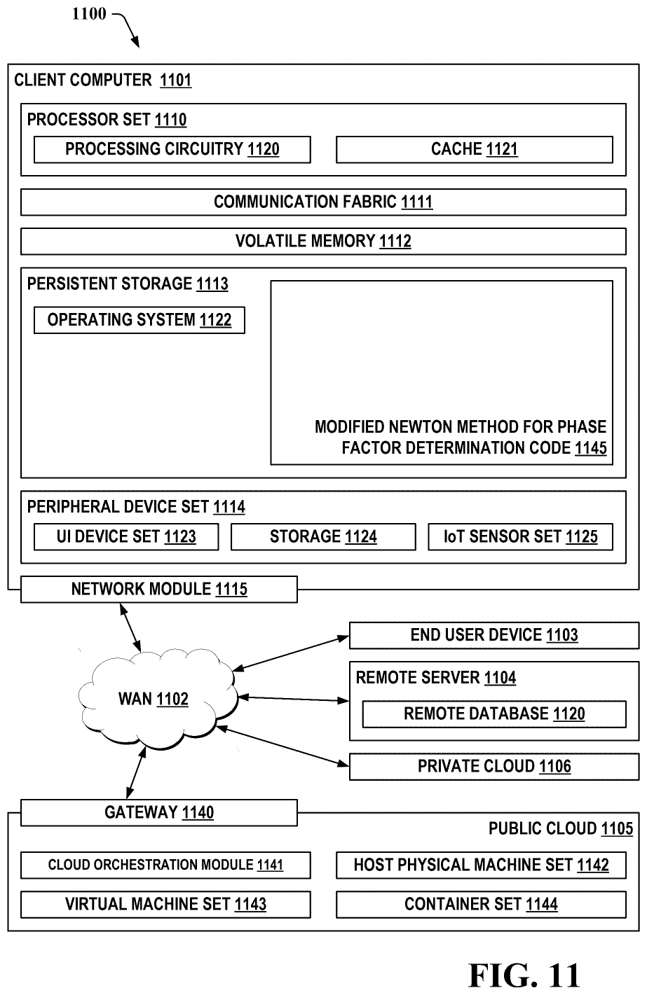

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 (e.g., system 100) as illustrated at FIG. 1, and/or systems thereof, can further comprise, be associated with and/or be coupled to one or more computer and/or computing-based elements described herein with reference to an operating environment, such as the operating environment 1100 illustrated at FIG. 11. For example, system 100 can be associated with, such as accessible via, a computing environment 1100 described below with reference to FIG. 11, such that aspects of processing can be distributed between system 100 and the computing environment 1100. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates block diagram of an example, non-limiting system 100 that can facilitate a Newton-type method for phase factor determination in quantum signal processing in accordance with one or more embodiments described herein. Aspects of systems (e.g., Newton method for phase factor determination system 102 and the like), apparatuses or processes in various embodiments of the present invention, can constitute one or more machine-executable components embodied within one or more machines (e.g., embodied in one or more computer readable mediums (or media) associated with one or more machines). Such components, when executed by the one or more machines (e.g., computers, computing devices, virtual machines, etc.), can cause the machines to perform the operations described.

Newton method for phase factor determination system 102 can comprise processor 104, memory 106, and phase factor determination component 101, the phase factor determination component 101 comprising input component 110, determination component 112, and/or evaluation component 114.

System 100 and/or the components of system 100 can be employed to use hardware and/or software to solve problems that are highly technical in nature (e.g., related to quantum computing, QSP, phase factor determination, etc.), that are not abstract and that cannot be performed as a set of mental acts by a human. Further, some of the processes performed may be performed by specialized computers for carrying out defined tasks related to phase factor determination in QSP. The system 100 and/or components of the system can be employed to solve new problems that arise through advancements in technologies mentioned above, quantum computing, and/or the like. The system 100 can provide technical improvements in terms of improving robustness and processing efficiency of phase factor determination in QSP by using a modified Newton method, etc.

Discussion turns briefly to processor 104, memory 106 and bus 108 of system 100. For example, in one or more embodiments, the system 100 can comprise processor 104 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 100 can comprise a computer-readable memory (e.g., memory 106) that can be operably connected to the processor 104. Memory 106 can store computer-executable instructions that, upon execution by processor 104, can cause processor 104 and/or one or more other components of system 100 (e.g., phase factor determination component 101, input component 110, determination component 112, evaluation component 114) to perform one or more actions. In one or more embodiments, memory 106 can store computer-executable components (e.g., phase factor determination component 101, input component 110, determination component 112, evaluation component 114).

System 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

As described above, in addition to the processor 104 and/or memory 106 described above, system 100 can comprise one or more computer and/or machine readable, writable and/or executable components and/or instructions that, when executed by processor 104, can enable performance of one or more operations defined by such component(s) and/or instruction(s).

In various embodiments, input component 110 can receive a target real-valued function 116 and a target real-valued function 118, denoted by f and g respectively. A real-valued function is a function that takes one or more real number inputs and maps them to a single real number as output. In various aspects, the target real-valued function 116 and the target real-valued function 118 can represent target transformations or operations to implement in QSP. Therefore, it can be desirable to approximate the target real-valued function 116 and the target real-valued function 118 to achieve the target transformations or operations in quantum computations.

In various cases, the target real-valued function 116 can be an even or an odd function, and the target real-valued function 118 can be a corresponding odd or even function. For example, if the target real-valued function 116 is even, the target real-valued function 118 can be odd. Conversely, if the target real-valued function 116 is odd, the target real-valued function 118 can be even. In various instances, the target real-valued function 116 and the target real-valued function 118 can be any suitable electronic data (e.g., one or more scalars, one or more vectors, one or more matrices, one or more tensors, one or more character strings, or any suitable combination thereof) that indicates, specifies, or otherwise conveys a first target function and a second target function.

In various embodiments, the input component 110 can receive a degree 122, denoted by d. In various aspects, the degree 122 can represent a number of phase factors 124 in QSP.

In various embodiments, the determination component 112 can, as described herein, determine a system of non-linear equations based on the target real-valued function 116 and the target real-valued function 118. In various aspects, the system of non-linear equations can comprise a first complex polynomial function of a first degree and a second polynomial function of a second degree used to approximate the target real-valued function 116 and the target real-valued function 118 respectively. The degree 122 can correspond to a maximum degree of the first complex polynomial function or the second complex polynomial function.

QSP can refer to a matrix-valued function (e.g., a function whose output is a matrix) defined by the following equation:

$${U}_{Φ} ( x ) = {e}^{i {ϕ}_{0} {σ}_{z}} {\prod }_{k = 1}^{d} ( W ( x ) {e}^{i {ϕ}_{k} {σ}_{z}} ) , where W ( x ) = {e}^{i c o {s}^{- 1} ( x ) {σ}_{x}}$$

The matrix-valued function can also be represented as the following equation:

$${U}_{Φ} ( x ) = [ \begin{matrix}P ( x ) & iQ ( x ) \sqrt{1 - {x}^{2}} \\ {iQ}^{*} ( x ) \sqrt{1 - {x}^{2}} & {P}^{*} ( x )\end{matrix} ] ,$$

where P denotes the first complex polynomial function with parity-(d mod 2) and Q denotes the second complex polynomial function with parity-(d−1 mod 2). In any case, it can be desirable to determine the phase factors 124, denoted by Φ, to approximate the target real-valued function 116 and the target real-valued function 118.

In various embodiments, input component 110 can receive a mode 120. In various aspects, the evaluation component 114 can determine phase factors 124 based on the mode 120. In various cases, the mode 120 can be any suitable electronic data (e.g., one or more scalars, one or more vectors, one or more matrices, one or more tensors, one or more character strings, or any suitable combination thereof). In various aspects, the mode 120 can specify how to combine the real or imaginary components of the first complex polynomial function and the second complex polynomial function within the system of non-linear equations to approximate the target real-valued function 116 and the target real-valued function 118.

In various instances, the system of non-linear equations can comprise a (d+1)-dimensional non-linear equation F=0 that can be defined by the following equation:

$${F}_{k} ( Φ ) = ( Re [ P ( {x}_{k} ; Φ ) ] - f ( {x}_{k} ) ) + \sqrt{1 - {x}_{k}^{2}} ( Re [ Q ( {x}_{k} ; Φ ) ] - g ( {x}_{k} ) ) , \\ k = 0 … , d where {x}_{c h e b} = {\{ {x}_{k} \}}_{k = 0}^{d}$$

denotes a set of Chebyshev nodes (e.g., specific points used in numerical interpolation, defined as the roots of Chebyshev polynomials, which are distributed to minimize interpolation error by clustering more densely at the interval's endpoints). A solution to the system of non-linear equations satisfies the equations Re[P]=P(f) and Re[Q]=P(g).

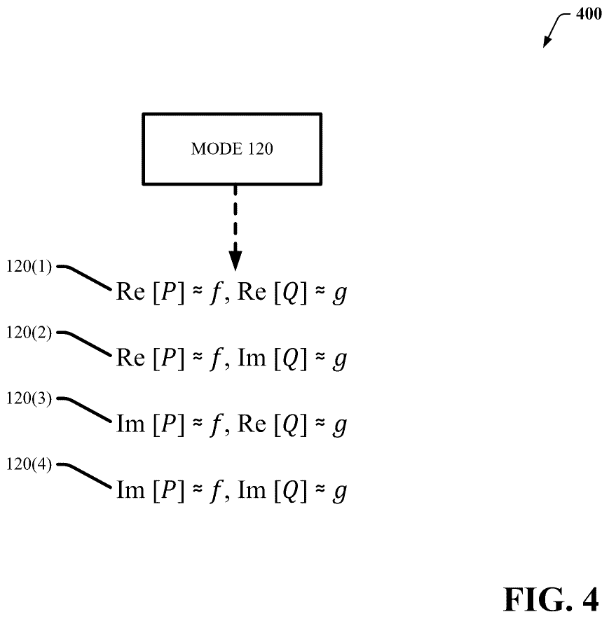

Note that, as described herein, in the non-linear equation F, the target real-valued function 116 and the target real-valued function 118 are approximated in a real part of the first complex polynomial function P and in a real part of the second complex polynomial function Q. However, the target real-valued function 116 and the target real-valued function 118 can be approximated in a real (e.g., denoted by Re) or imaginary part (e.g., denoted by Im) of the first complex polynomial function P and in a real part of the second complex polynomial function Q, as specified by the mode 120. Various aspects are described with respect to FIG. 4. In any case

In various embodiments, the evaluation component 114 can, as described herein, iteratively solve the system of non-linear equations to determine the phase factors 124 using a modified Newton method (e.g., simplified Newton's method). In various instances, the iteration process based on the modified Newton method can be defined by Φ⁽ⁿ⁺¹⁾=Φ⁽ⁿ⁾+ΔΦ⁽ⁿ⁾, F′(Φ⁽⁰⁾)ΔΦ⁽ⁿ⁾=−F(ΔΦ⁽ⁿ⁾).

In various cases, the evaluation component 114 can select an initial value of the phase factors 224 (e.g., phase factors Φ⁽⁰⁾) in the modified Newton's method. Specifically, the evaluation component 114 can select the initial value of the phase factors 224 such that an inverse of a Jacobian matrix is also a transpose of the Jacobian matrix at the initial value. In other words, at the initial value, the Jacobian matrix is orthogonal. Such initial value can improve convergence efficiency for determining the phase factors 124 by reducing bottlenecks of the modified Newton's method.

In various aspects, the evaluation component 114 can select the initial value of the phase factors 224 to be

$${Φ}^{( 0 )} = [ \frac{π}{2} , 0 , … , 0 ] .$$

By selecting this initial value of the phase factors 224, it can be shown that the Jacobian matrix J₀:=F′(Φ⁰) possesses a property defined by:

$${J}_{0} = {J}_{1} - {J}_{2} , where {J}_{1} = {( {( - 1 )}^{{k}_{1}} cos ( \frac{π ( 2 {k}_{1} + 1 ) ( 2 {k}_{2} + 1 )}{2 ( d + 1 )} ) )}_{{k}_{1} , {k}_{2}} and$$

$${J}_{2} = {( {( - 1 )}^{{k}_{1}} sin ( \frac{π ( 2 {k}_{1} + 1 ) ( 2 {k}_{2} + 1 )}{2 ( d + 1 )} ) )}_{{k}_{1} , {k}_{2}} .$$

Thus, it can be shown that

$$\frac{1}{d + 1} {J}_{0}^{T} {J}_{0} = \frac{1}{d + 1} {J}_{0} {J}_{0}^{T} = I .$$

In various embodiments, the evaluation component 114 can compute a matrix-vector multiplication J₀v using Fast Cosine Transform (FCT) and Fast Sine Transform (FST). By using FCT and FST to compute vector multiplications, a computational cost of O(d log(d)) can be achieved. Conversely, existing methods typically have a computational cost of O(d³), caused by bottlenecks that arise during matrix inversion. Thus, by selecting the initial value of the phase factors 124 such that the Jacobian matrix is orthogonal at the initial value, and by using FCT and FST for computation, efficiency of computation can be increased and significantly reduce bottlenecks of Modified Newton's method.

In any instance, the evaluation component 114 can iteratively solve the system of non-linear equations using the modified Newton method with the initial value of the phase factors 124 to determine the phase factors 124 based on the mode 120.

In various embodiments, the evaluation component 114 can alternatively utilize a quasi-Newton method (Broyden's method) or the exact Newton method to determine phase factors 124. The quasi-Newton method is an approximate version of the Newton method. This means that the accurate Jacobian matrix at the initial step, which is crucial to the convergence of Broyden's method, can be efficiently prepared with the selection of the initial value as described supra. By employing such accurately computed Jacobian matrix and applying Broyden's update rule, a higher convergence performance can be attained through the iterative process, which achieves O(d²) complexity. In other instances, the exact Newton method can be used, wherein the exact Newton method evaluates the Jacobian matrix with a complexity of O(d³) at each iteration.

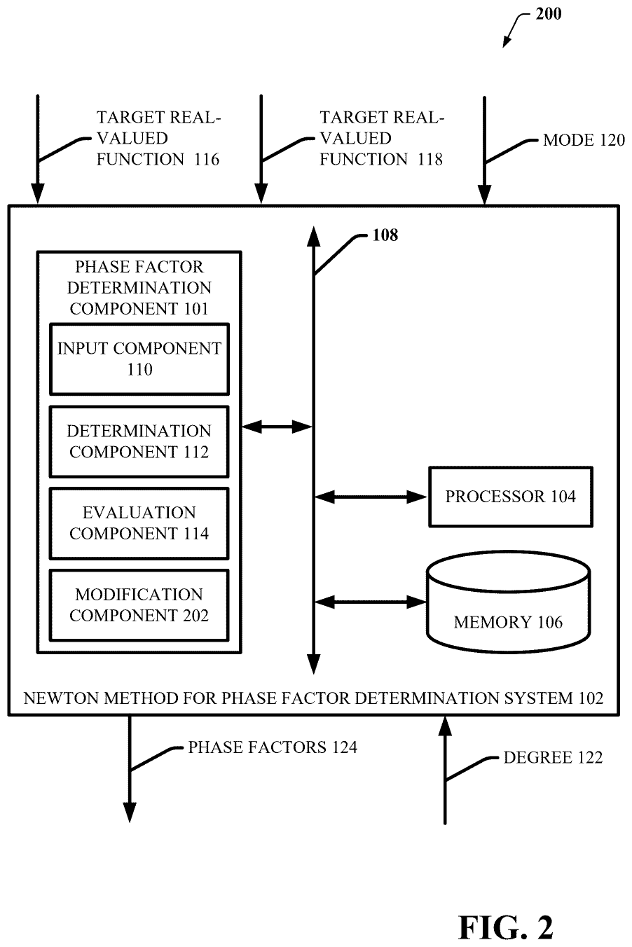

FIG. 2 illustrates a block diagram of example, non-limiting system 200 including a modification component that can facilitate a Newton-type method for phase factor determination in quantum signal processing in accordance with one or more embodiments described herein. As shown, the system 200 can, in some cases, comprise the same components as the system 100, and can further comprise a modification component 202.

In various embodiments, the modification component 202 can employ Aitken's acceleration technique (e.g., Aitken's delta-squared process) in the modified Newton's method to determine the phase factors 124. Aitken's acceleration technique is a series acceleration method used for accelerating a rate of convergence of a sequence. By employing Aitken's acceleration technique in the modified Newton's method, improved convergence performance can be achieved. In particular, the modification component 202 can employ Aitken's acceleration technique to modify a learning rate of iteratively solving the system of non-linear equations based on satisfaction of a criterion. Given a sequence xₙ, Aitken's acceleration technique generates a new sequence

$${x}_{n}^{′} ,$$

which converges faster than the sequence xₙ. Aitken's acceleration technique uses the following formula to compute the new sequence:

$${x}_{n}^{′} = {x}_{n} - \frac{{( {x}_{n + 1} - {x}_{n} )}^{2}}{{x}_{n + 2} - 2 {x}_{n + 1} + {x}_{n}}$$

To achieve acceleration of convergence in phase factor determination in QSP, the formula can be adapted to the following equation:

$${q}^{( n )} = \frac{Δ {Φ}^{( n - 1 )} Δ {Φ}^{( n )}}{Δ {Φ}^{( n - 1 )} \cdot ( {ΔΦ}^{( n )} - Δ {Φ}^{( n - 1 )} )}$$

In various aspects, the modification component 202 can examine a criterion at each iteration in the iteration process based on the modified Newton method for determining the phase factors 124. In response to satisfaction of the criterion, the modification component 202 can modify the learning rate. In various embodiments, the modification component 202 can modify the learning rate by adding a gradient scaled by a constant to the current phase factors (e.g., phase factors Φ⁽ⁿ⁾). The learning rate can control a rate of descending in the energy landscape. Thus, the modification can effectively adjust the learning rate to allow quicker convergence.

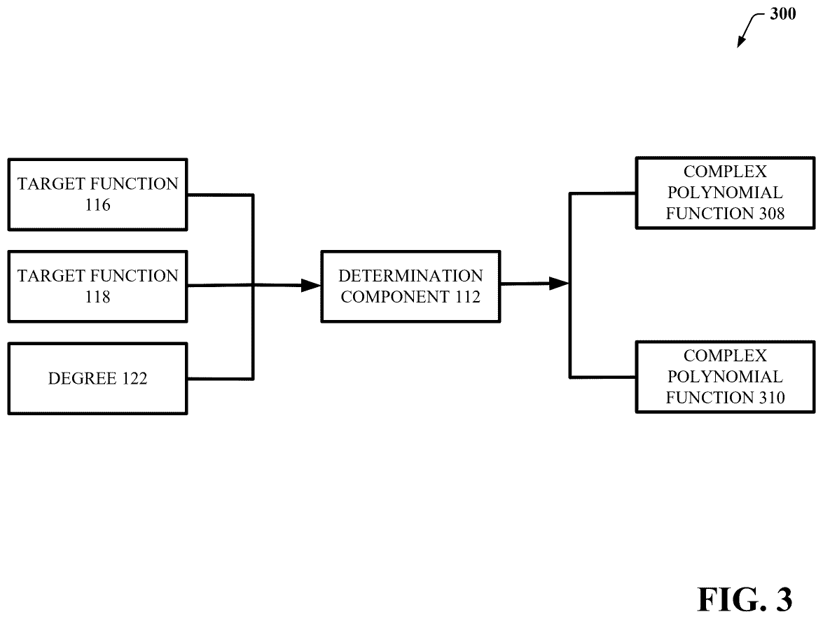

FIG. 3 illustrates an example, non-limiting block diagram 300 of determining a system of non-linear equations based on a first target real-valued function and a second target real-valued function in accordance with one or more embodiments described herein.

In various embodiments, the determination component 112 can receive the target real-valued function 116, the target real-valued function 118, and the degree 122. In various aspects, the determination component 112 can determine a system on non-linear equations based on the target real-valued function 116, the target real-valued function 118, and the degree 122. Specifically, the system of non-linear equations can comprise complex polynomial function 308 and complex polynomial function 310, denoted by P and Q respectively. In various aspects, the complex polynomial function 308 can approximate the target real-valued function 116 in a real or imaginary part of the complex polynomial function 308. Similarly, the complex polynomial function 310 can approximate the target real-valued function 118 in a real or imaginary part of the complex polynomial function 310. As previously described, the solution to the non-linear equation F=0 satisfies the equations Re[P]=P(f) and Re[Q]=P(g) (e.g., or Re[P]=P(f) and Im[Q]=P(g), Im[P]=P(f) and Re[Q]=P(g), or Im[P]=P(f) and Im[Q]=P(g) based on the mode 120). In any case, the projection, denoted by P, represents a polynomial interpolation at x_{cheb}, mapping from a space of functions on [0,1] to a space of polynomials with degrees less than d.

FIG. 4 illustrates an example, non-limiting block diagram 400 of modes for approximating target real-valued functions in accordance with one or more embodiments described herein.

In various embodiments, the input component 110 can receive the mode 120. In various instances, the mode 120 can specify how to combine the real or imaginary components of the first complex polynomial function and the second complex polynomial function within the system of non-linear equations to approximate the target real-valued function 116 and the target real-valued function 118.

For example, the mode 120 can be defined by mode 120(1). Mode 120(1) approximates the target real-valued function 116 in a real part of the first complex polynomial function P and approximates the target real-valued function 118 in a real part of the second complex polynomial function Q. As another example, the mode 120 can be defined by mode 120(2). Mode 120(2) approximates the target real-valued function 116 in a real part of the first complex polynomial function P and approximates the target real-valued function 118 in an imaginary part of the second complex polynomial function Q. As still another example, the mode 120 can be defined by mode 120(3). Mode 120(3) approximates the target real-valued function 116 in an imaginary part of the first complex polynomial function P and approximates the target real-valued function 118 in a real part of the second complex polynomial function Q. As even another example, the mode 120 can be defined by mode 120(4). Mode 120(4) approximates the target real-valued function 116 in an imaginary part of the first complex polynomial function P and approximates the target real-valued function 118 in an imaginary part of the second complex polynomial function Q.

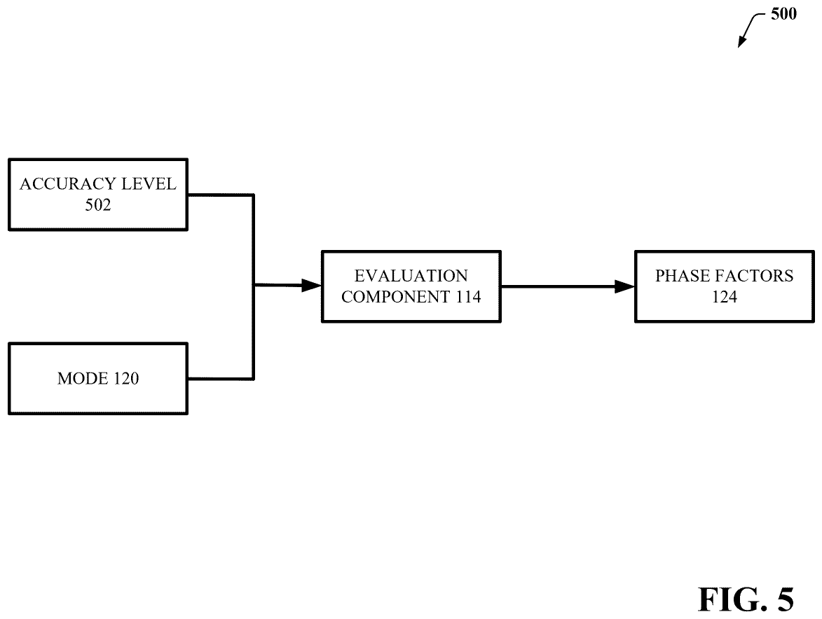

FIG. 5 illustrates an example, non-limiting block diagram 500 of determining phase factors based on an accuracy level and mode in accordance with one or more embodiments described herein.

In various embodiments, the evaluation component 114 can receive the mode 120 and an accuracy level 502. In various aspects, the evaluation component 114 can determine the phase factors 124 based on the mode 120 and the accuracy level 502. That is, based on the accuracy level 502, the evaluation component 114 can engage the modification component 202 to modify the learning rate to accelerate convergence. Modification of the learning rate can be executed based on satisfaction of a criterion. In various instances, the criterion can be based on the accuracy level 502, denoted by E. Specifically, the criterion can be defined by ∥ΔΦ⁽ⁿ⁾−Φ⁽ⁿ⁾·(ΔΦ⁽ⁿ⁾−ΔΦ⁽ⁿ⁻¹⁾)∥<ε to increase convergence efficiency within the accuracy level 502. In response to satisfaction of the criterion, the modification component 202 can modify the current phase factors (e.g., phase factors Φ⁽ⁿ⁾) as Φ⁽ⁿ⁾=Φ⁽ⁿ⁾+Φ⁽ⁿ⁾ΔΦ⁽ⁿ⁾. In various aspects, the modification component 202 can evaluate the criterion at each iteration in the iteration process of the modified Newton's method. As a result, the evaluation component 114 can receive the modified phase factors for the next iteration. In other instances, in response to not satisfying the criterion, the modification component 202 can refrain from modifying the current phase factors. As a result, the evaluation component 114 can utilize the unmodified phase factors for the next iteration.

In various embodiments, after convergence has been achieved, the evaluation component 114 can determine the phase factors 124 corresponding to the mode 120. For instance, the phase factors 124 can be denoted by Φ⁽ⁿ⁾=[Φ₀, . . . , Φ_{d}]. In various cases, if the mode 120 is defined by mode 120(1), the evaluation component 114 can output the phase factors 124 as Φ=Φ⁽ⁿ⁾. In other cases, if the mode 120 is defined by mode 120(2), the evaluation component 114 can output the phase factors 124 as

$$Φ = [ {Φ}_{0} + \frac{π}{4} , {Φ}_{1} , … , {Φ}_{d - 1} , {Φ}_{d} - \frac{π}{4} ] .$$

In still other cases, if the mode 120 is defined by mode 120(3), the evaluation component 114 can output the phase factors 124 as

$$Φ = [ {Φ}_{0} + \frac{π}{4} , {Φ}_{1} , … , {Φ}_{d - 1} , {Φ}_{d} + \frac{π}{4} ] .$$

In yet other cases, if the mode 120 is defined by mode 120(4), the evaluation component 114 can output the phase factors 124 as

$$Φ = [ {Φ}_{d} + \frac{π}{2} , {Φ}_{d - 1} , … , {Φ}_{0} ] .$$

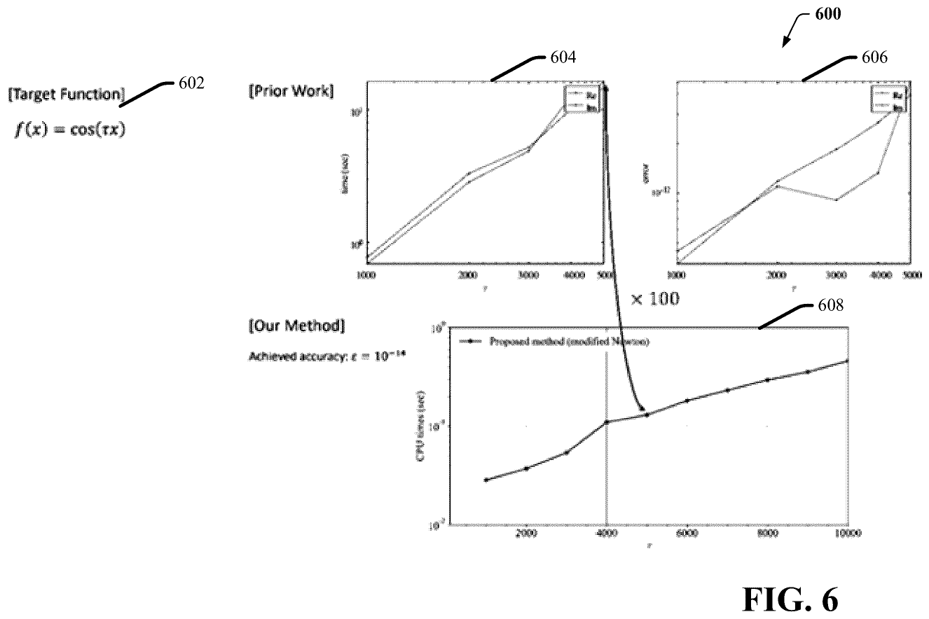

FIG. 6 illustrates an example, non-limiting diagram 600 of performance results of a Newton-type method for phase factor determination in accordance with one or more embodiments described herein.

Depicted in non-limiting diagram 600 are performance results of phase factor determination in QSP using the modified Newton's method against existing methods. As shown, the modified Newton's method exhibits a significant improvement in processing efficiency to determine the phase factors 124 for target function 602, defined by f(x)=cos(τx). In particular, the modified Newton's method performs 100 times faster than the existing methods. Furthermore, the modified Newton's method also achieves an accuracy of ε=10⁻¹⁴.

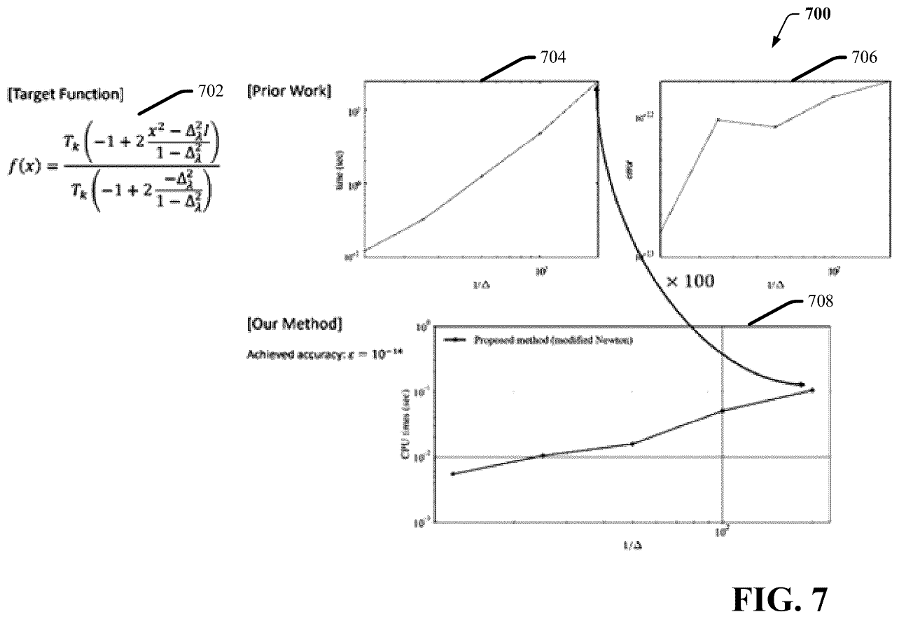

FIG. 7 illustrates an example, non-limiting diagram 700 of performance results of a Newton-type method for phase factor determination in accordance with one or more embodiments described herein.

Depicted in non-limiting diagram 600 are performance results of phase factor determination in QSP using the modified Newton's method against existing methods. As shown, the modified Newton's method exhibits a significant improvement in processing efficiency to determine the phase factors 124 for target function 602, defined by

$$f ( x ) = \frac{{T}_{k} ( - 1 + 2 \frac{{x}^{2} - Δ \frac{2}{λ} I}{1 - Δ \frac{2}{λ}} )}{{T}_{k} ( - 1 + 2 \frac{- Δ \frac{2}{λ}}{1 - Δ \frac{2}{λ}} )} .$$

In particular, the modified Newton's method performs 100 times faster than the existing methods. Furthermore, the modified Newton's method also achieves an accuracy of ε=10⁻¹⁴.

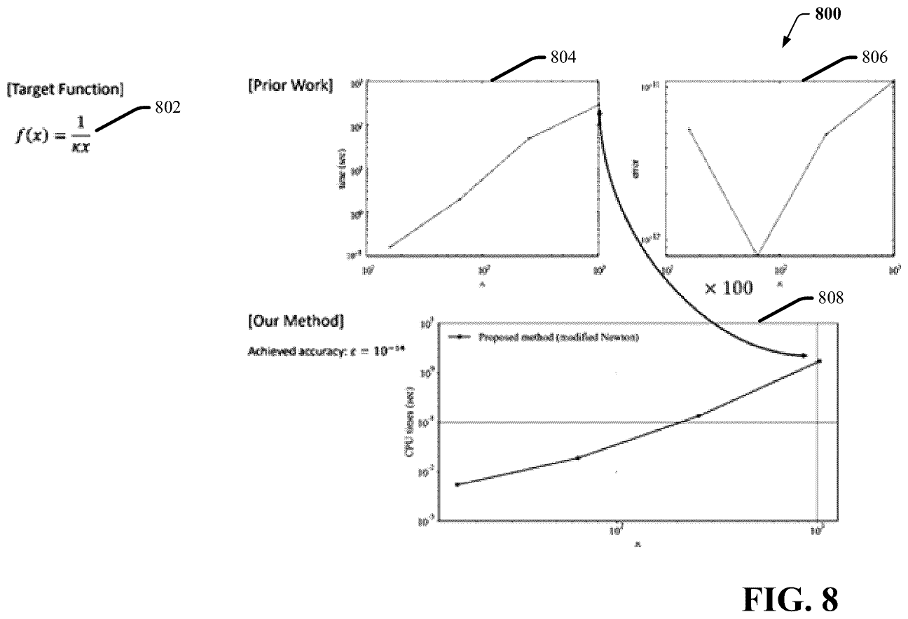

FIG. 8 illustrates an example, non-limiting diagram 800 of performance results of a Newton-type method for phase factor determination in accordance with one or more embodiments described herein.

Depicted in non-limiting diagram 600 are performance results of phase factor determination in QSP using the modified Newton's method against existing methods. As shown, the modified Newton's method exhibits a significant improvement in processing efficiency to determine the phase factors 124 for target function 602, defined by

$$f ( x ) = \frac{1}{k x} .$$

In particular, the modified Newton's method performs 100 times faster than the existing methods. Furthermore, the modified Newton's method also achieves an accuracy of ε=10⁻¹⁴.

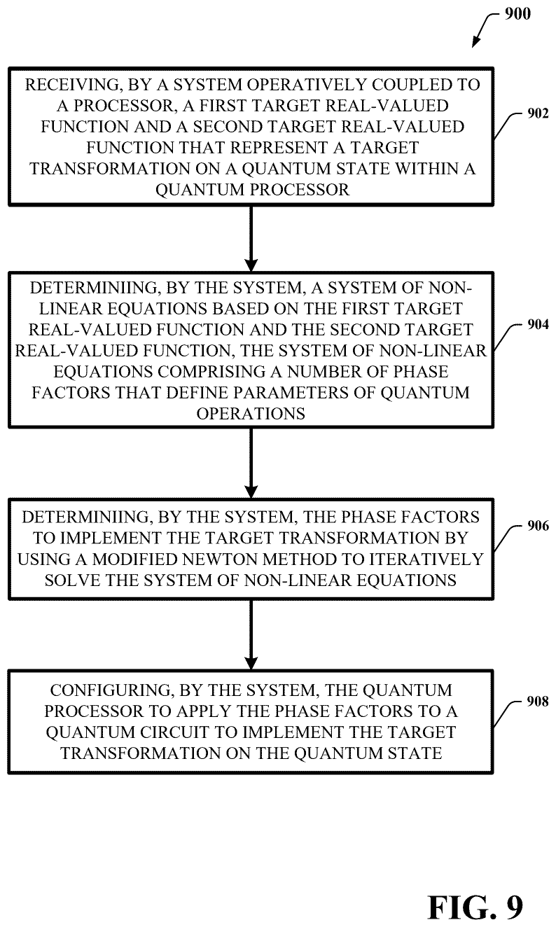

FIG. 9 illustrates a flow diagram of an example, non-limiting, computer implemented method 900 that facilitates a Newton-type method for phase factor determination in quantum signal processing in accordance with one or more embodiments described herein. Repetitive description of like elements employed in other embodiments described herein is omitted for sake of brevity.

At 902, non-limiting method 900 can include receiving, by a system (e.g., Newton method for phase factor determination system 102 and/or input component 110) operatively coupled to a processor (e.g., 104), a first target real-valued function and a second target real-valued function that represent a target transformation on a quantum state within a quantum processor.

At 904, non-limiting method 900 can include determining, by the system (e.g., determination component 112), a system of non-linear equations based on the first target real-valued function and the second target real-valued function, the system of non-linear equations comprising a number of phase factors that define parameters of quantum operations.

At 906, non-limiting method 900 can include determining, by the system (e.g., evaluation component 114), the phase factors to implement the target transformation by using a modified newton method to iteratively solve the system of non-linear equations.

At 908, non-limiting method 900 can include configuring, by the system, the quantum processor to apply the phase factors to a quantum circuit to implement the target transformation on the quantum state.

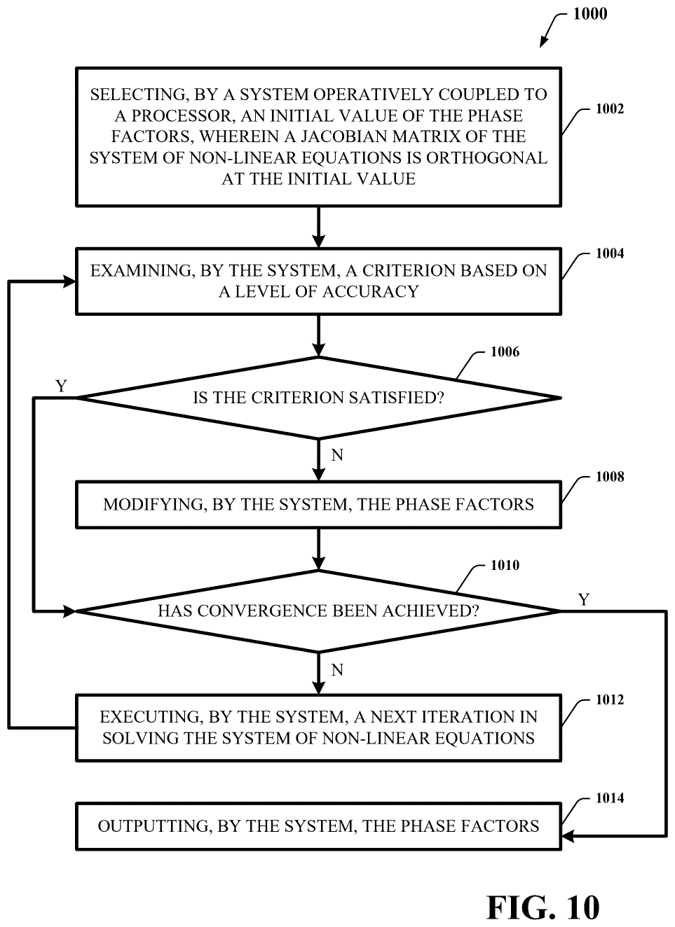

FIG. 10 illustrates a flow diagram of an example, non-limiting, computer implemented method 1000 that facilitates a Newton-type method for phase factor determination in quantum signal processing in accordance with one or more embodiments described herein. Repetitive description of like elements employed in other embodiments described herein is omitted for sake of brevity.

At 1002, non-limiting method 1000 can include selecting, by a system (e.g., Newton method for phase factor determination system 102 and/or determination component 112), an initial value of the phase factors, wherein a Jacobian matrix of the system of non-linear equations is orthogonal at the initial value.

At 1004, non-limiting method 1000 can include examining, by the system (e.g., modification component 202), a criterion based on a level of accuracy.

At 1006, non-limiting method 1000 can include determining, by the system (e.g., modification component 202), if the criterion is satisfied. If yes (e.g., the criterion is satisfied), the non-limiting method 1000 can proceed to 1010. If no (e.g., the criterion is not satisfied), the non-limiting method 1000 can proceed to 1008.

At 1008, non-limiting method 1000 can include modifying, by the system (e.g., modification component 202), the phase factors.

At 1010, non-limiting method 1000 can include determining, by the system (e.g., evaluation component 114), if convergence has been achieved. If yes (e.g., convergence has been achieved), the non-limiting method 1000 can proceed to 1014. If no (e.g., convergence has not been achieved), the non-limiting method 1000 can proceed to 1012.

At 1012, non-limiting method 1000 can include executing, by the system (e.g., evaluation component 114), a next iteration in solving the system of non-linear equations.

At 1014, non-limiting method 1000 can include outputting, by the system (e.g., evaluation component 114), the phase factors.

The Newton method for phase factor determination system 102 can provide technical improvements to a processing unit associated with Newton method for phase factor determination system 102. For example, by utilizing a Aitken's acceleration technique to modify a learning rate can exhibit improved convergence performance and increased processing efficiency, thereby reducing the workload of a processing unit (e.g., processor 104). In this example, by reducing the workload of such a processing unit (e.g., processor 104), Newton method for phase factor determination system 102 can thereby facilitate improved performance, improved efficiency, and/or reduced computational cost associated with such a processing unit. Further, by selecting an initial state of the phase factors such that the Jacobian matrix is orthogonal, the amount of computation resources utilized by Newton method for phase factor determination system 102 is reduced by decreasing the number of evaluations in the modified Newton method, thereby reducing or removing the additional workload the processing unit. Newton method for phase factor determination system 102 can thereby facilitate improved performance, improved efficiency, and/or reduced computational cost associated with phase factor determination in QSP.

A practical application of the Newton method for phase factor determination system 102 is that it allows for determination of phase factors in QSP with increased efficiency, accuracy, and robustness by utilizing a reduced amount of computing resources, in comparison to other methods. For example, phase factor determination is non-trivial, and existing methods are susceptible to numerical instability, high computational costs, and poor scalability for high-degree polynomials. By using a modified Newton method for phase factor determination, Newton method for phase factor determination system 102 can enable phase factor determination in QSP with improved scalability, decreased computation requirements, and improved processing efficiency. Therefore, Newton method for phase factor determination system 102 can enable phase factor determination in QSP that can be operated with reduced hardware requirements and computation resources, thus promoting efficient quantum computation.

It is to be appreciated that the Newton method for phase factor determination system 102 can utilize various combination of electrical components, mechanical components, and circuitry that cannot be replicated in the mind of a human or performed by a human as the various operations that can be executed by Newton method for phase factor determination system 102 and/or components thereof as described herein are operations that are greater than the capability of a human mind. For instance, the amount of data processed, the speed of processing such data, or the types of data processed by Newton method for phase factor determination system 102 over a certain period of time can be greater, faster, or different than the amount, speed, or data type that can be processed by a human mind over the same period of time. According to several embodiments, Newton method for phase factor determination system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that Newton method for phase factor determination system 102 can include information that is impossible to obtain manually by an entity, such as a human user. For example, the type, amount, and/or variety of information included in Newton method for phase factor determination system 102 can be more complex than information obtained manually by an entity, such as a human user.

FIG. 11 illustrates a block diagram of an example, non-limiting operating environment 1100 in which one or more embodiments described herein can be facilitated. FIG. 11 and the following discussion are intended to provide a general description of a suitable operating environment 1100 in which one or more embodiments described herein at FIGS. 1-10 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as modified newton method for phase factor determination code 1145. In addition to block 1145, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1145, as identified above), peripheral device set 1114 (including user interface (UI), device set 1125, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1145 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1145 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1125 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor, operably coupled to the memory, that executes at least one of the computer executable components that:
receives a first target real-valued function and a second target real-valued function that represent a target transformation on a quantum state within a quantum processor;
determines a system of non-linear equations based on the first target real-valued function and the second target real-valued function, the system of non-linear equations comprising a number of phase factors that define parameters of quantum operations;
determines the phase factors to implement the target transformation by using a modified Newton method to iteratively solve the system of non-linear equations; and
configures the quantum processor to apply the phase factors to a quantum circuit to implement the target transformation on the quantum state.

2. The system of claim 1, wherein the at least one of the computer executable components further:
approximates, based on a mode, the first target real-valued function in a real or imaginary part of a first complex polynomial function, wherein the first complex polynomial function is of a first degree; and
approximates, based on the mode, the second target real-valued function in a real or imaginary part of a second complex polynomial function, wherein the second complex polynomial function is of a second degree; and
configures the quantum processor to apply the phase factors based on the mode used for approximating the first target real-valued function and the second target real-valued function.

3. The system of claim 1, wherein the first target real-valued function or the second target real-valued function correspond to polynomial interpolations at Chebyshev points.

4. The system of claim 2, wherein the phase factors represent the first target real-valued function and the second target real-valued function as the first complex polynomial function and the second complex polynomial function respectively if the first target real-valued function and the second target real-valued function are polynomial functions.

5. The system of claim 1, wherein the at least one of the computer executable components further:
sets a level of accuracy of the phase factors for solving the system of non-linear equations to implement the target transformation on the quantum state at the level of accuracy.

6. The system of claim 2, wherein the number of phase factors corresponds to a maximum degree between the first degree and the second degree.

7. The system of claim 1, wherein iteratively solving the system of non-linear equations to determine the phase factors to implement the target transformation on the quantum state comprises using a quasi-Newton method.

8. The system of claim 1, wherein iteratively solving the system of non-linear equations to determine the phase factors to implement the target transformation on the quantum state comprises using Newton's method.

9. The system of claim 1, wherein the modified Newton method comprises:
selecting an initial value of the phase factors, wherein a Jacobian matrix of the system of non-linear equations is orthogonal at the initial value.

10. The system of claim 5, wherein the at least one of the computer executable components further:
accelerates convergence using Aitken's acceleration technique, wherein Aitken's acceleration technique comprises:
modifying a learning rate of iteratively solving the system of non-linear equations based on satisfaction of a criterion; and
examining the criterion based on the level of accuracy.

11. A computer-implemented method, comprising:
receiving, by a system operatively coupled to a processor, a first target real-valued function and a second target real-valued function that represent a target transformation on a quantum state within a quantum processor;
determining, by the system, a system of non-linear equations based on the first target real-valued function and the second target real-valued function, the system of non-linear equations comprising a number of phase factors that define parameters of quantum operations;
determining, by the system, the phase factors to implement the target transformation by using a modified Newton method to iteratively solve the system of non-linear equations; and
configuring, by the system, the quantum processor to apply the phase factors to a quantum circuit to implement the target transformation on the quantum state.

12. The computer-implemented method of claim 11, further comprising:
approximating, by the system, and based on a mode, the first target real-valued function in a real or imaginary part of a first complex polynomial function, wherein the first complex polynomial function is of a first degree; and
approximating, by the system and based on the mode, the second target real-valued function in a real or imaginary part of a second complex polynomial function, wherein the second complex polynomial function is of a second degree; and
configures the quantum processor to apply the phase factors based on the mode used for approximating the first target real-valued function and the second target real-valued function.

13. The computer-implemented method of claim 11, wherein the first target real-valued function or the second target real-valued function correspond to polynomial interpolations at Chebyshev points.

14. The computer-implemented method of claim 12, wherein the phase factors represent the first target real-valued function and the second target real-valued function as the first complex polynomial function and the second complex polynomial function respectively if the first target real-valued function and the second target real-valued function are polynomial functions.

15. The computer-implemented method of claim 11, further comprising:
setting, by the system, a level of accuracy of the phase factors for solving the system of non-linear equations to implement the target transformation on the quantum state at the level of accuracy.

16. The computer-implemented method of claim 11, wherein iteratively solving the system of non-linear equations to determine the phase factors to implement the target transformation on the quantum state comprises using a quasi-Newton method or Newton's method.

17. The computer-implemented method of claim 11, further comprising:
selecting, by the system, an initial value of the phase factors, wherein a Jacobian matrix of the system of non-linear equations is orthogonal at the initial value.

18. The computer-implemented method of claim 15, further comprising:
accelerating, by the system, convergence using Aitken's acceleration technique, wherein Aitken's acceleration technique comprises:
modifying a learning rate of iteratively solving the system of non-linear equations based on satisfaction of a criterion; and
examining the criterion based on the level of accuracy.

19. A computer program product facilitating phase factor determination in quantum signal processing, the computer program product comprising a computer readable storage medium having program instructions embodied therewith, the program instructions executable by a processor to cause the processor to:
receive, by the processor, a first target real-valued function and a second target real-valued function that represent a target transformation on a quantum state within a quantum processor;
determine, by the processor, a system of non-linear equations based on the first target real-valued function and the second target real-valued function, the system of non-linear equations comprising a number of phase factors that define parameters of quantum operations;
determine the phase factors to implement the target transformation by using a modified Newton method to iteratively solve the system of non-linear equations; and
configure the quantum processor to apply the phase factors to a quantum circuit to implement the target transformation on the quantum state.

20. The computer program product of claim 19, wherein the program instructions are further executable by the processor to cause the processor to:
approximate, based on a mode, the first target real-valued function in a real or imaginary part of a first complex polynomial function, wherein the first complex polynomial function is of a first degree; and
approximate, based on the mode, the second target real-valued function in a real or imaginary part of a second complex polynomial function, wherein the second complex polynomial function is of a second degree; and
configure the quantum processor to apply the phase factors based on the mode used for approximating the first target real-valued function and the second target real-valued function.
